(19) United States
(12) Patent Application Publication
(10) Pub. No.: US 2024/0160480 A1
(43) Pub. Date: May 16, 2024

(54) SYSTEMS AND METHODS PROVIDING MULTI-CHANNEL COGNITIVE VIRTUAL ASSISTANCE FOR RESOURCE TRANSFER REQUESTS

(71) Applicant: BANK OF AMERICA CORPORATION, Charlotte, NC (US)

(72) Inventors: Indradeep Dantuluri, Harrisburg, NC (US); Pavan Chayanam, Alamo, CA (US)

(73) Assignee: BANK OF AMERICA CORPORATION, Charlotte, NC (US)

(21) Appl. No.: 17/984,560

(22) Filed: Nov. 10, 2022

(51) Int. Cl. G06F 9/50; G10L 15/22

(52) U.S. Cl. CPC G06F 9/5027; G10L 15/22; G10L 2015/223

(57) ABSTRACT

Systems, computer program products, and methods are described herein for multi-channel cognitive virtual assistance for resource transfer requests. The present disclosure is configured to receive a request from a first user device to complete a resource transfer between a first resource account and a second resource account; analyze the request via a machine learning engine and generate an intent based on a communication contained in the request; generate an automated notification based on the generated intent and forward the automated notification to a second user device; receive an approval, denial, or change request in response to the automated notification; based on the approval, denial, or change request, initiate a resource action between the first resource account and the second resource account.

### TECHNOLOGICAL FIELD

Example embodiments of the present disclosure relate to systems and methods for multi-channel cognitive virtual assistance for resource transfer requests. Multiple devices may be utilized by the multi-channel resource system to receive and process data to complete anticipate and respond to user needs.

### BACKGROUND

Existing systems require a user to navigate multiple applications and potentially perform numerous redundant actions to execute electronic resource activities or source responsive data to their support needs. Conventional systems present multiple difficulties in usability surrounding the ability to initiate secure resource transfers between accounts managed by separate individuals, particularly in instances where one user supervises the use of multiple other resource accounts owned by others. As such, applicant has identified a number of deficiencies and problems associated with multi-channel cognitive virtual assistance for resource transfer requests. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for multi-channel cognitive virtual assistance for resource transfer requests. The present invention provides an advantageous solution for multi-channel cognitive virtual assistance for resource transfer requests, particularly in instances where one user supervises the use of one or more resource accounts owned by others (e.g., dependents, children, family members, or the like). There is a need for a streamlined solution that allows supervised users to initiate resource transfer requests from one or more supervising users in a secure manner that allows the supervising user to quickly analyze and respond to such requests. Ideally, the solution would be integrated within an existing cognitive assistance solution such that both users can easily access and make changes to initiated resource transfer requests, provide important context, quickly authorize, deny, or edit resource transfer requests, and ultimately transfer resources in an expeditious manner.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

Embodiments of the invention relate to systems, computer implemented methods, and computer program products for establishing intelligent, proactive and responsive communication with a user, comprising a multi-channel user input platform for performing electronic activities in an integrated manner from a single interface, the invention comprising: receive a request from a first user device to complete a resource transfer between a first resource account and a second resource account; analyze the request via a machine learning engine and generate an intent based on a communication contained in the request; generate an automated notification based on the generated intent and forward the automated notification to a second user device; receive an approval, denial, or change request in response to the automated notification; based on the approval, denial, or change request, initiate a resource action between the first resource account and the second resource account.

In some embodiments, the first resource account and the second resource account are managed by a common entity system.

In some embodiments, analyzing the request via the machine learning engine and generating an intent further comprises conducting an analysis of audio communication content in comparison to resource account history data.

In some embodiments, the automated notification further comprises a description of the resource transfer of the request in addition to one or more contextual details.

In some embodiments, the request further comprises a resource amount and one or more products or services, and the system is further configured to: compare the request to a resource transfer history between the first resource account and the second resource account; and determine that the request is within a historical range of resource amount or matches products or services of one or more historical resource transfers.

In some embodiments, the apparatus is further configured to determine a location of the first user device and forward the location of the first user device to the second user device as a part of the automated notification.

In some embodiments, the apparatus is further configured to transmit a final approval request to the second user device prior to initiating the resource action between the first resource account and the second resource account.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIG. 1A depicts a system environment 100 providing a system for multi-channel cognitive virtual assistance for resource transfer requests, in accordance with one embodiment of the present invention;

FIG. 1B illustrates an exemplary machine learning engine 146 subsystem architecture, in accordance with an embodiment of the invention;

FIG. 2 provides a block diagram of the user device 104, in accordance with one embodiment of the invention;

FIG. 3 depicts a process flow of a language processing module 200, in accordance with one embodiment of the present invention;

FIG. 4 depicts a high-level process flow 400 for multi-channel cognitive virtual assistance for resource transfer requests, in accordance with one embodiment of the present invention;

FIG. 5 depicts a high-level process flow 500 for multi-channel cognitive virtual assistance for resource transfer requests, in accordance with one embodiment of the present invention; and

FIG. 6 depicts a process flow 600 for multi-channel cognitive virtual assistance for resource transfer requests, in accordance with one embodiment of the present invention.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers, or any other aspect of the operations of the organization. As such, the entity may be any institution, group, association, financial institution, establishment, company, union, authority, or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository—a storage location where one or more resources are organized, stored, and retrieved electronically using a computing device.

As used herein, a “resource transfer,” “resource distribution,” or “resource allocation” may refer to any transaction, activities, or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e., paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding, or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

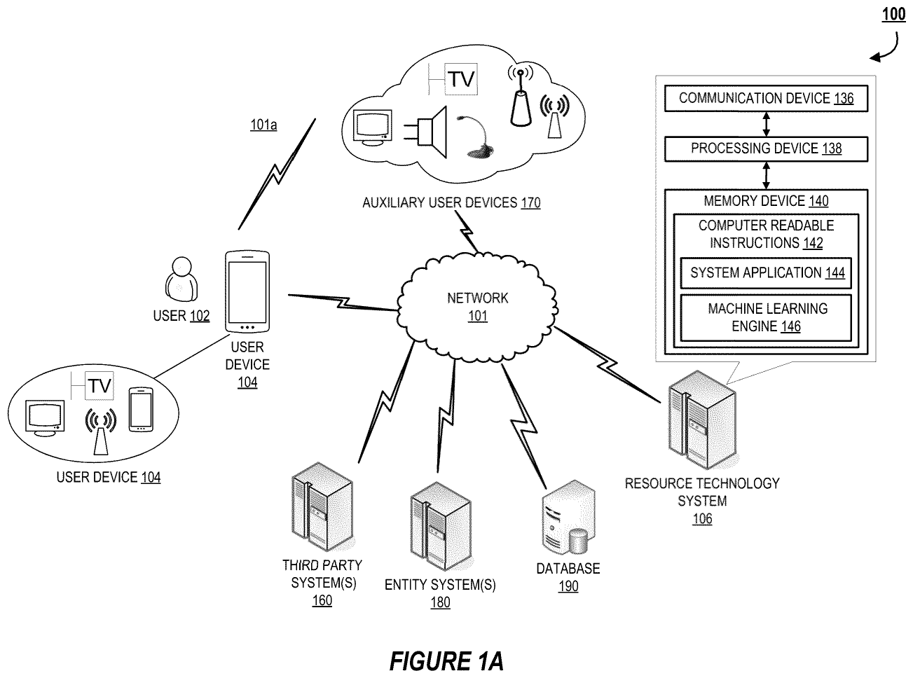

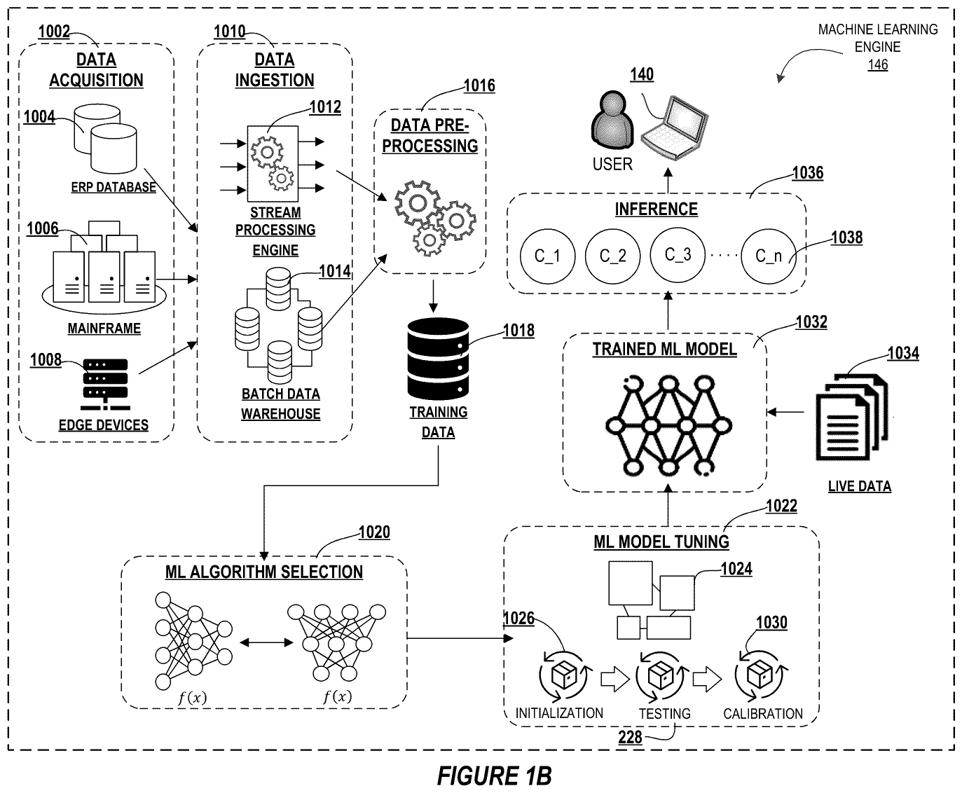

FIG. 1A depicts a system environment 100 providing a system for multi-channel cognitive virtual assistance for resource transfer requests, in accordance with one embodiment of the present invention. As illustrated in FIG. 1A, a resource technology system 106, configured for providing an intelligent, proactive, and responsive application or system, at a user device 104, which facilitates execution of electronic activities in an integrated manner. The resource technology system 106 can adapt to the user's natural communication and its various modes by allowing seamless switching between communication channels/mediums in real time or near real time. The resource technology system is operatively coupled, via a network 101 to one or more user devices 104, auxiliary user devices 170, to entity systems 180, database 190, third party systems 160, and other external systems/third-party servers not illustrated herein. In this way, the resource technology system 106 can send information to and receive information from multiple user devices 104 and auxiliary user devices 170 to provide an integrated platform with multi-channel cognitive assistive capabilities to a user 102, and particularly to the user device 104. At least a portion of the system is typically configured to reside on the user device 104, on the resource technology system 106 (for example, at the system application 144), and/or on other devices and system and is an intelligent, proactive, responsive system that facilitates execution of intelligent communication in an integrated manner. Furthermore, the system is capable of seamlessly adapting to and switch between the user's natural communication and its various modes (such as speech or audio communication, textual communication in the user's preferred natural language, gestures, and the like), and is typically infinitely customizable by the resource technology system 106 and/or the user 102.

The network 101 may be a global area network (GAN), such as the Internet, a wide area network (WAN), a local area network (LAN), or any other type of network or combination of networks. The network 101 may provide for wireline, wireless, or a combination wireline and wireless communication between devices on the network 101. The network 101 is configured to establish an operative connection between otherwise incompatible devices, for example establishing a communication channel, automatically and in real time, between the one or more user devices 104 and one or more of the auxiliary user devices 170, (for example, based on reeving a user input, or when the user device 104 is within a predetermined proximity or broadcast range of the auxiliary user device(s) 170), as illustrated by communication channel 101a. Therefore, the system, via the network 101 may establish, operative connections between otherwise incompatible devices, for example by establishing a communication channel 101a between the one or more user devices 104 and the auxiliary user devices 170. In this regard, the network 101 (and particularly the communication channels 101a) may take the form of contactless interfaces, short range wireless transmission technology, such near-field communication (NFC) technology, Bluetooth® low energy (BLE) communication, audio frequency (AF) waves, wireless personal area network, radiofrequency (RF) technology, and/or other suitable communication channels. Tapping may include physically tapping the external apparatus, such as the user device 104, against an appropriate portion of the auxiliary user device 170 or it may include only waving or holding the external apparatus near an appropriate portion of the auxiliary user device without making physical contact with the auxiliary user device.

In some embodiments, the user 102 is an individual that wishes to conduct one or more activities with resource technology system 106 using the user device 104. In some embodiments, the user 102 may access the resource technology system 106, and/or the entity system 180 through a user interface comprising a webpage or a user application. Hereinafter, “user application” is used to refer to an application on the user device 104 of the user 102, a widget, a webpage accessed through a browser, and the like. As such, in some instances, the user device may have multiple user applications stored/installed on the user device 104. In some embodiments, the user application is a user application 538, also referred to as a “user application” herein, provided by and stored on the user device 104 by the resource technology system 106. In some embodiments the user application 538 may refer to a third-party application or a user application stored on a cloud used to access the resource technology system 106 and/or the auxiliary user device 170 through the network 101, communicate with or receive and interpret signals from auxiliary user devices 170, and the like. In some embodiments, the user application is stored on the memory device of the resource technology system 106, and the user interface is presented on a display device of the user device 104, while in other embodiments, the user application is stored on the user device 104.

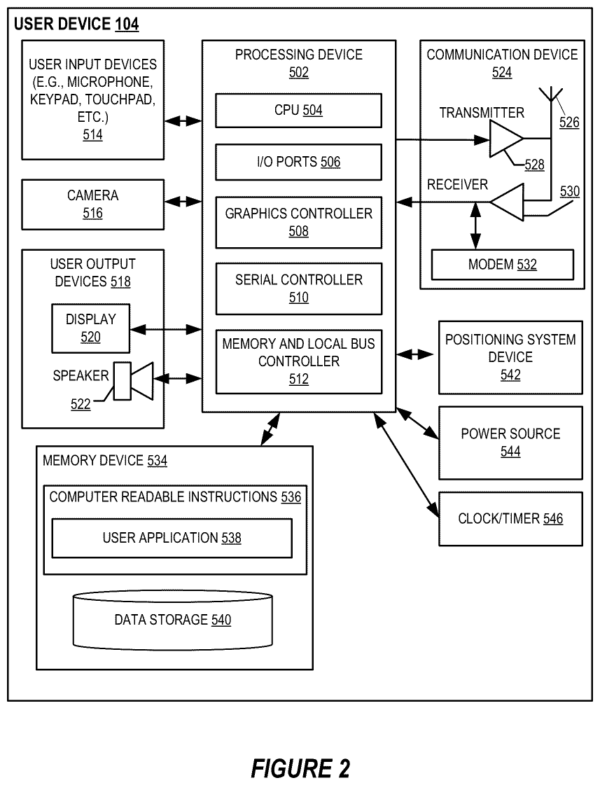

The user 102 may subsequently navigate through the interface or initiate one or more user activities or resource transfers using a central user interface provided by the user application 538 of the user device 104. In some embodiments, the user 102 may be routed to a particular destination or entity location using the user device 104. In some embodiments the auxiliary user device 170 requests and/or receives additional information from the resource technology system 106/the third-party systems 160 and/or the user device 104 for authenticating the user and/or the user device, determining appropriate queues, executing information queries, and other functions. FIG. 2 provides a more in-depth illustration of the user device 104.

As further illustrated in FIG. 1A, the resource technology system 106 generally comprises a communication device 136, at least one processing device 138, and a memory device 140. As used herein, the term “processing device” generally includes circuitry used for implementing the communication and/or logic functions of the system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 138 is operatively coupled to the communication device 136 and the memory device 140. The processing device 138 uses the communication device 136 to communicate with the network 101 and other devices on the network 101, such as, but not limited to the third-party systems 160, auxiliary user devices 170 and/or the user device 104. As such, the communication device 136 generally comprises a modem, server, wireless transmitters, or other devices for communicating with devices on the network 101. The memory device 140 typically comprises a non-transitory computer readable storage medium, comprising computer readable/executable instructions/code, such as the computer-readable instructions 142, as described below.

As further illustrated in FIG. 1A, the resource technology system 106 comprises computer-readable instructions 142 or computer readable program code 142 stored in the memory device 140, which in one embodiment includes the computer-readable instructions 142 of a system application 144 (also referred to as a “system application” 144). The computer readable instructions 142, when executed by the processing device 138 are configured to cause the system 106/processing device 138 to perform one or more steps described in this disclosure to cause out systems/devices to perform one or more steps described herein. In some embodiments, the memory device 140 includes a data storage for storing data related to user transactions and resource entity information, but not limited to data created and/or used by the system application 144. Resource technology system 106 also includes machine learning engine 146. In some embodiments, the machine learning engine 146 is used to analyze received data to identify complex patterns and intelligently improve the efficiency and capability of the resource technology system 106 to analyze received voice print data and identify unique patterns. In some embodiments, the machine learning engine 146 may include supervised learning techniques, unsupervised learning techniques, or a combination of multiple machine learning models that combine supervised and unsupervised learning techniques. In some embodiments, the machine learning engine may include an adversarial neural network that uses a process of encoding and decoding to adversarial train one or more machine learning models to identify relevant patterns in received data received from one or more channels of communication.

FIG. 1A further illustrates one or more auxiliary user devices 170, in communication with the network 101. The auxiliary user devices 170 may comprise peripheral devices such as speakers, microphones, smart speakers, and the like, display devices, a desktop personal computer, a mobile system, such as a cellular phone, smart phone, personal data assistant (PDA), laptop, wearable device, a smart TV, a smart speaker, a home automation hub, augmented/virtual reality devices, or the like.

In the embodiment illustrated in FIG. 1A, and described throughout much of this specification, a “system” configured for performing one or more steps described herein refers to the services provided to the user via the user application, that may perform one or more user activities either alone or in conjunction with the resource technology system 106, and specifically, the system application 144, one or more auxiliary user device 170, and the like in order to provide an intelligent and proactive virtual voice assistant.

Typically, the central user interface is a computer human interface, and specifically a natural language/conversation user interface provided by the resource technology system 106 to the user 102 via the user device 104 or auxiliary user device 170. The various user devices receive and transmit user input to the entity systems 180 and resource technology system 106. The user device 104 and auxiliary user devices 170 may also be used for presenting information regarding user activities, providing output to the user 102, and otherwise communicating with the user 102 in a natural language of the user 102, via suitable communication mediums such as audio, textual, and the like. The natural language of the user comprises linguistic variables such as words, phrases and clauses that are associated with the natural language of the user 102. The system is configured to receive, recognize, and interpret these linguistic variables of the user input and perform user activities and resource activities accordingly. In this regard, the system is configured for natural language processing and computational linguistics. In many instances, the system is intuitive, and is configured to anticipate user requirements, data required for a particular activity and the like, and request activity data from the user 102 accordingly.

Also pictured in FIG. 1A are one or more third party systems 160, which are operatively connected to the resource technology system 106 via network 101 to transmit data associated with user activities, user authentication, user verification, resource actions, and the like. For instance, the capabilities of the resource technology system 106 may be leveraged in some embodiments by third party systems in order to authenticate user actions based on data provided by the third party systems 160, third party applications running on the user device 104 or auxiliary user devices 170, as analyzed and compared to data stored by the resource technology system 106, such as data stored in the database 190 or stored at entity systems 180. In some embodiments, the multi-channel cognitive processing capabilities may be provided as a service by the resource technology system 106 to the entity systems 180, third party systems 160, or additional systems and servers not pictured, using an application programming interface (“API”) designed to simplify the communication protocol for client-side requests for data or services from the resource technology system 106. In this way, the capabilities offered by the present invention may be leveraged by multiple parties other than the those controlling the resource technology system 106 or entity systems 180.

FIG. 1B illustrates an exemplary machine learning (ML) subsystem architecture 1000, in accordance with an embodiment of the invention. The machine learning subsystem 1000 may include a data acquisition engine 1002, data ingestion engine 1010, data pre-processing engine 1016, ML model tuning engine 1022, and inference engine 1036.

The data acquisition engine 1002 may identify various internal and/or external data sources to generate, test, and/or integrate new features for training the machine learning model 1024. These internal and/or external data sources 1004, 1006, and 1008 may be initial locations where the data originates or where physical information is first digitized. The data acquisition engine 1002 may identify the location of the data and describe connection characteristics for access and retrieval of data. In some embodiments, data is transported from each data source 1004, 1006, or 1008 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 1004, 1006, and 1008 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 1002 from these data sources 1004, 1006, and 1008 may then be transported to the data ingestion engine 1010 for further processing.

Depending on the nature of the data imported from the data acquisition engine 1002, the data ingestion engine 1010 may move the data to a destination for storage or further analysis. Typically, the data imported from the data acquisition engine 1002 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 1002, the data may be ingested in real-time, using the stream processing engine 1012, in batches using the batch data warehouse 1014, or a combination of both. The stream processing engine 1012 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 1014 collects and transfers data in batches according to scheduled intervals, trigger events, or any other logical ordering.

In machine learning, the quality of data and the useful information that can be derived therefrom directly affects the ability of the machine learning model 1024 to learn. The data pre-processing engine 1016 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 1016 may implement feature extraction and/or selection techniques to generate training data 1018. Feature extraction and/or selection is a process of dimensionality reduction by which an initial set of data is reduced to more manageable groups for processing. A characteristic of these large data sets is many variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 1018 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 1022 may be used to train a machine learning model 1024 using the training data 1018 to make predictions or decisions without explicitly being programmed to do so. The machine learning model 1024 represents what was learned by the selected machine learning algorithm 1020 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms can adjust their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 1022 may repeatedly execute cycles of experimentation 1026, testing 1028, and tuning 1030 to optimize the performance of the machine learning algorithm 1020 and refine the results in preparation for deployment of those results for consumption or decision making. To this end, the ML model tuning engine 1022 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 1018. A fully trained machine learning model 1032 is one whose hyperparameters are tuned and model accuracy maximized.

The trained machine learning model 1032, similar to any other software application output, can be persisted to storage, file, memory, or application, or looped back into the processing component to be reprocessed. More often, the trained machine learning model 1032 is deployed into an existing production environment to make practical business decisions based on live data 1034. To this end, the machine learning subsystem 1000 uses the inference engine 1036 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 1038) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 1038) live data 1034 based on how similar they are to one another to solve exploratory challenges where little is known about the data, provide a description or label (e.g., C_1, C_2 . . . C_n 1038) to live data 1034, such as in classification, and/or the like. These categorized outputs, groups (clusters), or labels are then presented to the user input system 130. In still other cases, machine learning models that perform regression techniques may use live data 1034 to predict or forecast continuous outcomes.

It will be understood that the embodiment of the machine learning subsystem 1000 illustrated in FIG. 1B is exemplary and that other embodiments may vary. As another example, in some embodiments, the machine learning subsystem 1000 may include more, fewer, or different components.

FIG. 2 provides a block diagram of the user device 104, in accordance with one embodiment of the invention. The user device 104 may generally include a processing device or processing device 502 communicably coupled to devices such as, a memory device 534, user output devices 518 (for example, a user display device 520, or a speaker 522), user input devices 514 (such as a microphone, keypad, touchpad, touch screen, and the like), a communication device or network interface device 524, a power source 544, a clock or other timer 546, a visual capture device such as a camera 516, a positioning system device 542, such as a geo-positioning system device like a GPS device, an accelerometer, and the like. The processing device 502 may further include a central processing unit 504, input/output (I/O) port controllers 506, a graphics controller or graphics processing device (GPU) 208, a serial bus controller 510 and a memory and local bus controller 512.

The processing device 502 may include functionality to operate one or more software programs or applications, which may be stored in the memory device 534. For example, the processing device 502 may be capable of operating applications such as the multi-channel resource application 122. The user application 538 may then allow the user device 104 to transmit and receive data and instructions from the other devices and systems of the environment 100. The user device 104 comprises computer-readable instructions 536 and data storage 540 stored in the memory device 534, which in one embodiment includes the computer-readable instructions 536 of a multi-channel resource application 122. In some embodiments, the user application 538 allows a user 102 to access and/or interact with other systems such as the entity system 180, third party system 160, or resource technology system 106. In one embodiment, the user 102 is a maintaining entity of a resource technology system 106, wherein the user application enables the user 102 to configure the resource technology system 106 or its components. In one embodiment, the user 102 is a customer of a financial entity and the user application 538 is an online banking application providing access to the entity system 180 wherein the user may interact with a resource account via a user interface of the multi-channel resource application 122, wherein the user interactions may be provided in a data stream as an input via multiple channels. In some embodiments, the user 102 may a customer of third-party system 160 that requires the use or capabilities of the resource technology system 106 for authorization or verification purposes.

The processing device 502 may be configured to use the communication device 524 to communicate with one or more other devices on a network 101 such as, but not limited to the entity system 180 and the resource technology system 106. In this regard, the communication device 524 may include an antenna 526 operatively coupled to a transmitter 528 and a receiver 530 (together a “transceiver”), modem 532. The processing device 502 may be configured to provide signals to and receive signals from the transmitter 528 and receiver 530, respectively. The signals may include signaling information in accordance with the air interface standard of the applicable BLE standard, cellular system of the wireless telephone network and the like, that may be part of the network 101. In this regard, the user device 104 may be configured to operate with one or more air interface standards, communication protocols, modulation types, and access types. By way of illustration, the user device 104 may be configured to operate in accordance with any of a number of first, second, third, and/or fourth-generation communication protocols or the like. For example, the user device 104 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with fifth-generation (5G) wireless communication protocols, millimeter wave technology communication protocols, and/or the like. The user device 104 may also be configured to operate in accordance with non-cellular communication mechanisms, such as via a wireless local area network (WLAN) or other communication/data networks. The user device 104 may also be configured to operate in accordance, audio frequency, ultrasound frequency, or other communication/data networks.

The user device 104 may also include a memory buffer, cache memory or temporary memory device operatively coupled to the processing device 502. Typically, one or more applications, are loaded into the temporarily memory during use. As used herein, memory may include any computer readable medium configured to store data, code, or other information. The memory device 534 may include volatile memory, such as volatile Random-Access Memory (RAM) including a cache area for the temporary storage of data. The memory device 534 may also include non-volatile memory, which can be embedded and/or may be removable. The non-volatile memory may additionally or alternatively include an electrically erasable programmable read-only memory (EEPROM), flash memory or the like.

Though not shown in detail, the system further includes one or more entity systems 180 which is connected to the user device 104 and the resource technology system 106 and which may be associated with one or more entities, institutions, third party systems 160, or the like. In this way, while only one entity system 180 is illustrated in FIG. 1A, it is understood that multiple networked systems may make up the system environment 100. The entity system 180 generally comprises a communication device, a processing device, and a memory device. The entity system 180 comprises computer-readable instructions stored in the memory device, which in one embodiment includes the computer-readable instructions of an entity application. The entity system 180 may communicate with the user device 104 and the resource technology system 106 to provide access to user accounts stored and maintained on the entity system 180. In some embodiments, the entity system 180 may communicate with the resource technology system 106 during an interaction with a user 102 in real-time, wherein user interactions may be logged and processed by the resource technology system 106 to analyze interactions with the user 102 and reconfigure the machine learning model in response to changes in a received or logged data stream. In one embodiment, the system is configured to receive data for decisioning, wherein the received data is processed and analyzed by the machine learning model to determine a conclusion. In some embodiments, communications between one or more users and one or more user devices is logged and used for decisioning and contextual analysis for further communication from the resource technology system 106 via an alternate communication channel (e.g., an audio conversation between a service representative and customer may be recorded for quality assurance purposes, converted using a speech-to-text algorithm, and analyzed using the machine learning engine 146 in order to inform later communications sent from the resource technology system 106 to the user device 104).

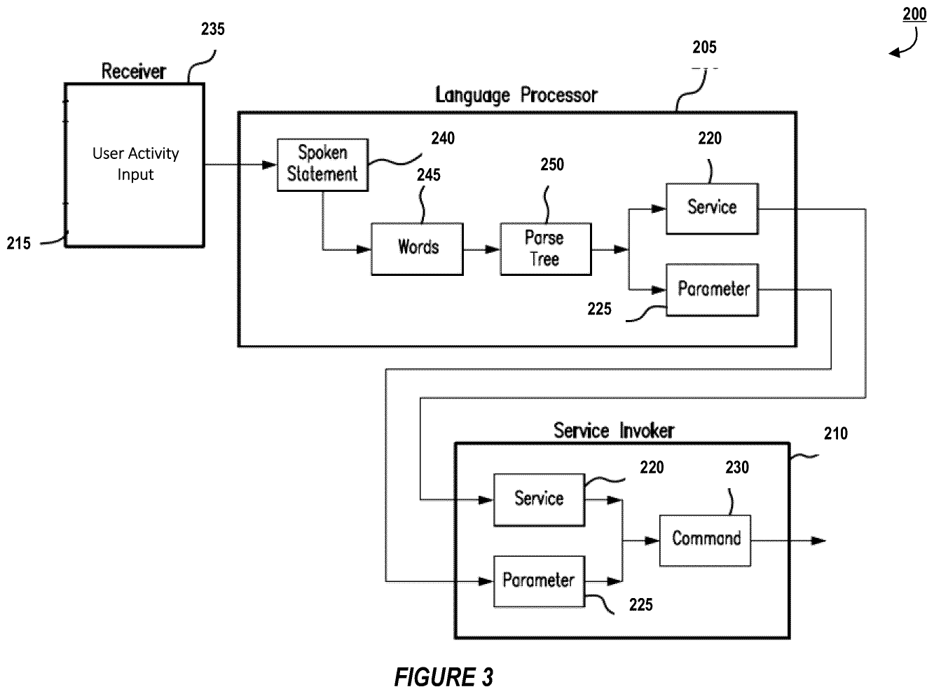

FIG. 3 depicts a high-level process flow of a language processing module 200 of a multi-channel cognitive virtual assistance for resource transfer requests, in accordance with one embodiment of the invention. The language processing module is typically a part of the user application 538 of the user device, although in some instances the language processing module resides on the resource technology system 106. The natural language of the user may include linguistic variables such as verbs, phrases and clauses that are associated with the speech or written text produced by the user. The system, and the language processing module 200, is configured to receive, recognize and interpret these linguistic variables of the user input and infer context. In this regard, the language processing module 200 is configured for natural language processing and computational linguistics. As illustrated in the embodiment provided in FIG. 2, the language processing module 200 may include a receiver 235 (such as a microphone, a touch screen or another user input or output device), a language processor 205 and a service invoker 210. It is understood that these components may not exist in all embodiments, particularly in those where conversations between two human users are logged and later processed by the language processing module. The illustrative embodiment shown in FIG. 2 simply illustrates one means of input that the system may incorporate in order to receive data for linguistic processing.

As shown in FIG. 2, receiver 235 receives a user activity input 215 from the user, such as a spoken statement, provided using an audio communication medium. Although described in this embodiment in the context of an audio communication medium, the language processing module 200 is not limited to this medium and is configured to operate on input received through other mediums such as textual input, graphical input (such as sentences/phrases in images or videos), and the like. As an example, the user may provide an activity input comprising the sentence “I'm interested in product X.” The receiver 235 may receive the user activity input 215 and forward the user activity input 215 to the language processor 205. An example algorithm for the receiver 235 is as follows: wait for user activity input; receive user activity input; identify medium of user activity input as spoken statement; and forward spoken statement 240 to language processor 205.

The language processor 205 receives spoken statement 240 and processes spoken statement 240 to determine an appropriate service 220 to invoke to respond to the user activity input 215 and any parameters 225 needed to invoke service 220. The language processor 205 may detect a plurality of words 245 in spoken statement 240. Using the previous example, words 245 may include: interested, and product X. The language processor 205 may process the detected words 245 to determine the service 220 to invoke to respond to user activity input 215.

The language processor 205 may generate a parse tree based on the detected words 245. Parse tree may indicate the language structure of spoken statement 240. Using the previous example, parse tree may indicate a verb and infinitive combination of “interested” and an object of “product” with the modifier of “X.” The language processor 205 may then analyze the parse tree to determine the intent of the user and the activity associated with the conversation to be performed. For example, based on the example parse tree, the language processor 205 may determine that the user may be interested in purchasing a particular product or group of products related to product X. Facilitating the purchase of product X, or other associated products (e.g., products identified as being related to the same category of product X), may represent an identified service 220. For instance, if the user is identified as interested in purchasing a house or a car, the identified service 220 may be a loan. Additionally, the system may recognize that certain parameters 225 are required to complete the service 220, such as required authentication in order to initiate a resource transfer from a user account and may identify these parameters 225 before forwarding information to the service invoker 210.

An example algorithm for the language processor 205 is as follows: wait for spoken statement 240; receive spoken statement 240 from receiver 235; parse spoken statement 240 to detect one or more words 245; generate parse tree using the words 245; detect an intent of the user by analyzing parse tree; use the detected intent to determine a service to invoke; identify values for parameters requires to complete the service 220; and forward service 220 and the values of parameters 225 to service invoker 210.

Next, the service invoker 210 receives determined service 220 comprising required functionality and the parameters 225 from the language processor 205. The service invoker 210 may analyze service 220 and the values of parameters 225 to generate a command 230. Command 230 may then be sent to instruct that service 220 be invoked using the values of parameters 225. In response, the language processor 205 may invoke a resource transfer functionality of a user application 538 of the user device, for example, by extracting pertinent elements and embedding them within the central user interface, or by requesting authentication information from the user via the central user interface. An example algorithm for service invoker 210 is as follows: wait for service 220; receive service 220 from the language processor 205; receive the values of parameters 225 from the language processor 205; generate a command 230 to invoke the received service 220 using the values of parameters 225; and communicate command 230 to invoke service 220.

In some embodiments, the system also includes a transmitter that transmits audible signals, such as questions, requests and confirmations, back to the user. For example, if the language processor 205 determines that there is not enough information in spoken statement 240 to determine which service 220 should be invoked, then the transmitter may communicate an audible question back to the user for the user to answer. The answer may be communicated as another spoken statement 240 that the language processor 205 can process to determine which service 220 should be invoked. As another example, the transmitter may communicate a textual request back to the user. If the language processor 205 determines that certain parameters 225 are needed to invoke a determined service 220 but that the user has not provided the values of these parameters 225. For example, if the user had initially stated “I want to purchase product x,” the language processor 205 may determine that certain values for service 220 are missing. In response, the transmitter may communicate the audible request “how many/much of product X would you like to purchase?” As yet another example, the transmitter may communicate an audible confirmation that the determined service 220 has been invoked. Using the previous example, the transmitter may communicate an audible confirmation stating “Great, let me initiate that transaction.” In this manner, the system may dynamically interact with the user to determine the appropriate service 220 to invoke to respond to the user.

In other embodiments, the spoken statement 240 may be contextualized and mapped based on other user input, such as input from a second user. For example, in an embodiment where the system logs a conversation between a customer (“first user”) and a service representative of the entity (“second user”), the system may map certain information provided by the first user to a use case, data category, data retrieval process, or the like. This process may occur in tandem with the analysis of the audio input data or spoken statement 240 as previously described. For example, the system may employ the use of linguistic analysis to infer a contextual significance of a question from the second user to the first user, and may identify the response as containing the answer to the question (e.g., an agent or service representative may ask a customer for their customer identification code, and the customer may respond in natural language with their user identification code, user name, or the like). In this case, while the system may infer the context of the conversation between the first user and the second user via linguistic analysis, the system may also parse this information and map the identified question and answer data to an alphanumeric number and software service call (e.g., a customer response containing a username may be mapped to a software service call “retrieveCustomerDetails”). In this way, the system may employ the use of the software service call to later retrieve information already provided by the user during a logged conversation in order to enhance the user experience in interacting with the virtual assistant at a later time.

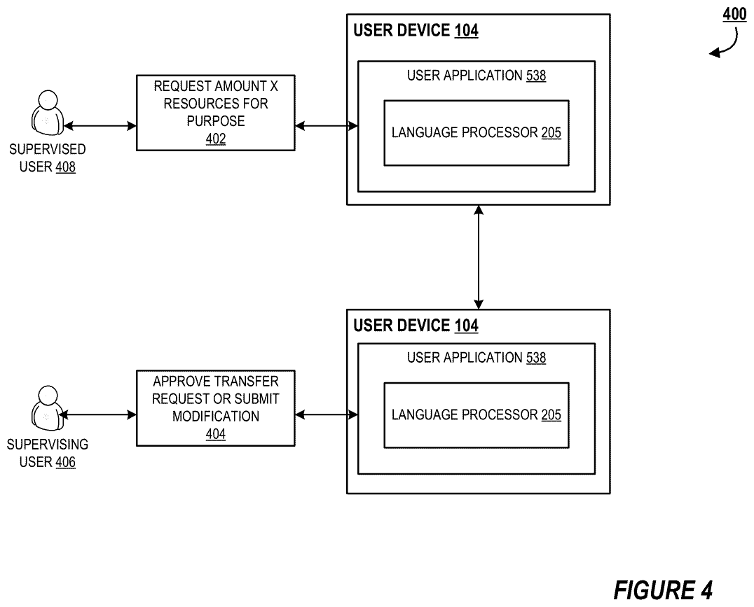

FIG. 4 depicts a high-level process flow 300 for multi-channel cognitive virtual assistance for resource transfer requests, in accordance with one embodiment of the present invention. As shown in FIG. 4, the process may include a supervised user 408 and a supervising user 406, which may each represent a subset of the user 102 as described in FIG. 1A. It is understood that “supervised user” may refer to a user whose resource account may be managed, owned by, or otherwise accessed by or linked to a supervising user 406 or supervising user's resource account. For instance, a supervised user 408 may include a child, dependent, family member, or the like of the supervising user 406. In this way, the supervised user 408 may be monitored or tracked by the supervising user 406 for the supervising user 406 to aid in the development of responsible resource transfer habits, or the like. It is understood that this linking of accounts is enabled via the resource technology system 106 maintaining two separate resource accounts for the respective users which may be linked or otherwise granted special permission to transfer resources between them, view balances, track resource actions, or the like.

In some instances, it is understood that the supervised user 408 may require, or desire, additional resources in their resource account, and may choose to request a resource transfer from the supervising user 406. In some embodiments, the supervised user 408 may require resources for a specific purpose or reason, such as to purchase food, clothing, school supplies, gas, pay for a service, or the like. In some embodiments, the supervised user 408 may be on a schedule to receive a set amount of resources from the supervising user 406 at particular frequency or interval of time, or the like. In other embodiments, the supervising user 406 may desire to set limits on the amount, purpose, product categories, service categories, frequency, or interval of resource transfers made to the supervised user 408 (e.g., setting a weekly or monthly allowance, setting a budget for products such as restaurant food, gas, or the like). In some embodiments, the supervised user 408 may input a request of a specific amount for a specific purpose via the user device 104, as shown in block 402 of FIG. 4. In this way, the supervised user 408 may manually initiate a communication to the user device 104 of the supervising user 406. In some embodiments, it is understood that a multi-channel virtual assistant may be employed by either of the users in order to initiate the request or respond to the request, as indicated by the user application 538 and the language processor 205. In some embodiments, the user application 538 may convert received audio communication from either use into an intent to complete a specific action, such as initiate a request for resources for a specific amount or purpose or approve, modify, or deny resource transfer requests, in the case of the supervising user 406.

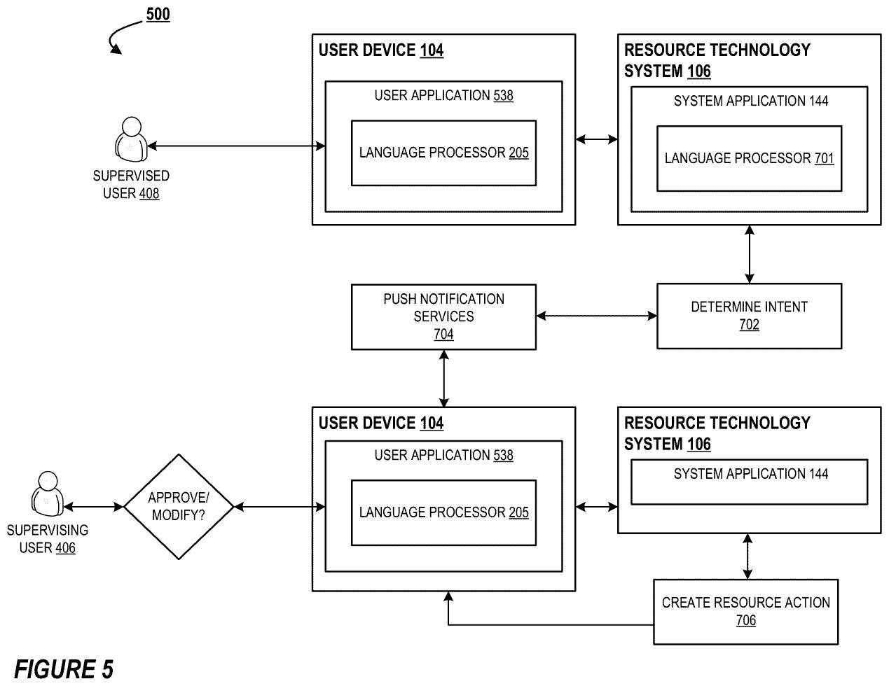

FIG. 5 depicts a high-level process flow 400 for multi-channel cognitive virtual assistance for resource transfer requests, in accordance with one embodiment of the present invention. FIG. 5 expands on the process for initiating, approving, modifying, or denying resource transfer requests in more detail versus the process flow of FIG. 4. As shown in FIG. 5, the resource technology system 106 may be employed on the backend of the process to streamline the process of analyzing intent, generating notifications, or creating and modifying resource transfer requests or resource actions. As shown in FIG. 5, the process 500 may begin whereby a supervised user 408 interacts with a user device 104. In some embodiments, an audio communication from the supervised user 408 may be processed using an onboard natural language processor 205 on the user device 104 as a part of the user application 538. In other embodiments, the resource technology system 106 may receive the audio communication, or a communication in another channel or form, such as a text communication, and analyze the communication via the system application 144, using the language processor 501.

In this way, the resource technology system may access additional data stored regarding one or more users or their respective resource accounts to further contextualize a given communication and properly infer an intent associated with such communication. For instance, while the onboard natural language processor of the user device 104 may employ the same initial syntax breakdown to identify subjects, intents, or the like, the machine learning engine 146 of the resource technology system 106 may additionally employ the resource technology system 106 with the ability to analyze and determine intent, as shown in block 702. In other embodiments, the machine learning engine 146 may be further employed to analyze previous resource transfer or actions history data in order to determine a predicted resource action given the user's location, account history, previous resource transfers, or the like. For instance, the system 106 may request location data from the user device 104 and refer to a positioning database or other database such as database 190 in order to determine that the user is located at a gas station, or the like. In some embodiments, the system 106 may further analyze the resource action history of the supervised user 408 to determine an average amount authorized by the supervising user 406 for products in the convenience store or gas station category. In some embodiments, the supervised user 408 may simply record and transmit an audio communication with the words “ask mom or dad for gas money,” and the system 106 may contextualize this communication in order to determine an intent that the supervised user 408 is located at a gas station and usually requires an amount in the range of $20-40, or the like.

After the system 106 has determined an intent, as shown in block 702, the system 206 may employ push notification services 704 in order to transmit an appropriate notification to the user device 104 of the supervising user 406. For instance, the system may generate an automated message including the determination of intent, the rationale for determining the intent, or may attach a transcribed version or portion of the audio communication from the supervised user 408. For instance, the notification may include a message such as “supervised user has requested money for gas—supervised user usually requires about $20-40 for this purpose and is located at gas station X at [address]. Click here to access the communication from supervised user.” In this way, the system 106 may provide the supervising user 406 with relevant information related to the resource request and may provide a link to download the audio communication or a text-based transcript of the audio communication.

As further shown in FIG. 5, the system may provide an option to the supervising user to approve, modify, or deny the resource request via their respective user device 104 using the user application 538. In some embodiments, the system 106 may be further employed to create a specific resource action and forward it back to the user device 104 for approval. For instance, after the supervised user 406 has approved the resource request, the system 106 may generate a real-time payment for the specified amount and may revert a message back to the user device 104 of the supervising user 406 to confirm the transaction before making the transfer between the users' resource accounts. In some embodiments, the system 106 may also review the resource transaction history, balance, or the like of the supervising user 406 in order to determine additional relevant information via the use of machine learning engine 146. For instance, in some embodiments, the system 106 may determine that the supervising user 406 has already made a number of similar resource transfers in a period of time, such as the same week, month, or the like. In this way, the system 106 may alert the supervising user 106 of this fact via a message such as “Authorize transfer of resources in the amount of $20 to supervised user? We note that you have already transferred a similar amount this week for the same purpose.” In this instance, the supervising user 406 may realize that the supervised user 408 has been driving more often than usual, or may be requesting resources for a different purpose, such as to buy snacks at the gas station, or the like. The supervising user 406 may then modify the resource transfer, choose to withdraw preliminary approval of the resource transfer, or choose to contact the supervised user 408 for more information. It is understood that the supervising user 406 and the supervised user 408 may communicate with the system 106 at any time using audio communication, allowing the users to complete the process in a hands-free manner.

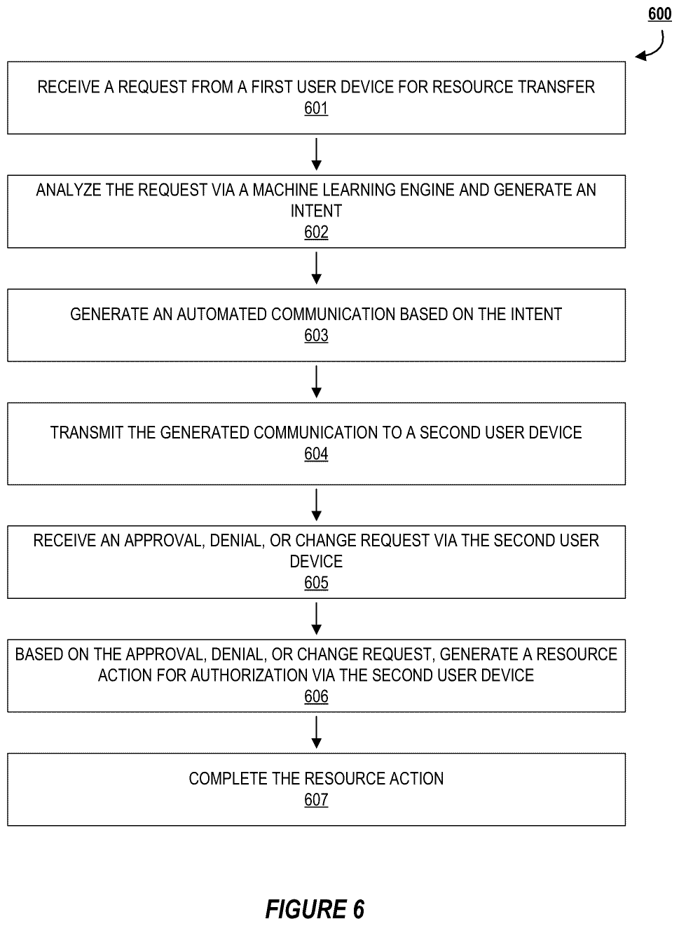

FIG. 6 depicts a process flow 600 for multi-channel cognitive virtual assistance for resource transfer requests, in accordance with one embodiment of the present invention. As shown in block 601, the process begins wherein the system 106 receives a request from a first user device for a resource transfer. In some embodiments, the request may be in the form of an audio communication via a virtual assistant through a user application, via a text communication via a virtual assistance through a user application, or the like. The system analyzes the request via the machine learning engine 146 in order to determine and generate an intent which is communicated to a second user device, as shown in blocks 602 and 603.

The second user device may be reviewed via the supervising user 406 via the graphical user interface of the second user device, as shown in block 604. At this stage, the supervising user 408 may choose to approve, deny, or communicate a change request regarding the resource transfer request, as shown in block 605. In some embodiments, the approval, denial, or change request may be in the form of an audio communication via a virtual assistant through a user application, via a text communication via a virtual assistance through a user application, or the like. In some embodiments, the user communication may be received via multiple channels. In some embodiments the user communication may be analyzed via a backend processing engine such as the machine learning engine 146 in order to determine contextual significance of the content of the user request with regard to resource action history of the supervised or supervising user's resource accounts, or the like. As indicated in block 606, the system may generate a resource action for authorization via the second user device by the supervised user 406 based on the approval denial or change request. For instance, the system may alter the amount of resources to be transferred in response to the request if the supervised user 406 indicates that they would like to adjust the amount prior to executing the resource action. Finally, as shown in block 607, the system may complete the resource action by initiating a resource transfer between the accounts of the supervised and supervising users.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for multi-channel cognitive virtual assistance for resource transfer requests, the system comprising:
at least one non-transitory storage device; and
at least one processor coupled to the at least one non-transitory storage device, wherein the at least one processor is configured to:
receive a request from a first user device to complete a resource transfer between a first resource account and a second resource account;
analyze the request via a machine learning engine and generate an intent based on a communication contained in the request;
generate an automated notification based on the generated intent and forward the automated notification to a second user device;
receive an approval, denial, or change request in response to the automated notification;
based on the approval, denial, or change request, initiate a resource action between the first resource account and the second resource account.

2. The system of claim 1, wherein the first resource account and the second resource account are managed by a common entity system.

3. The system of claim 1, wherein analyzing the request via the machine learning engine and generating an intent further comprises conducting an analysis of audio communication content in comparison to resource account history data.

4. The system of claim 1, wherein the automated notification further comprises a description of the resource transfer of the request in addition to one or more contextual details.

5. The system of claim 1, wherein the request further comprises a resource amount and one or more products or services, and the system is further configured to:
compare the request to a resource transfer history between the first resource account and the second resource account; and
determine that the request is within a historical range of resource amount or matches products or services of one or more historical resource transfers.

6. The system of claim 1, wherein the system is further configured to determine a location of the first user device and forward the location of the first user device to the second user device as a part of the automated notification.

7. The system of claim 1, wherein the system is further configured to transmit a final approval request to the second user device prior to initiating the resource action between the first resource account and the second resource account.

8. A computer program product for multi-channel cognitive virtual assistance for resource transfer requests, the computer program product comprising a non-transitory computer-readable medium comprising code causing an apparatus to:
receive a request from a first user device to complete a resource transfer between a first resource account and a second resource account;
analyze the request via a machine learning engine and generate an intent based on a communication contained in the request;
generate an automated notification based on the generated intent and forward the automated notification to a second user device;
receive an approval, denial, or change request in response to the automated notification;
based on the approval, denial, or change request, initiate a resource action between the first resource account and the second resource account.

9. The computer program product of claim 8, wherein the first resource account and the second resource account are managed by a common entity system.

10. The computer program product of claim 8, wherein analyzing the request via the machine learning engine and generating an intent further comprises conducting an analysis of audio communication content in comparison to resource account history data.

11. The computer program product of claim 8, wherein the automated notification further comprises a description of the resource transfer of the request in addition to one or more contextual details.

12. The computer program product of claim 8, wherein the request further comprises a resource amount and one or more products or services, further configured to:
compare the request to a resource transfer history between the first resource account and the second resource account; and
determine that the request is within a historical range of resource amount or matches products or services of one or more historical resource transfers.

13. The computer program product of claim 8, wherein the apparatus is further configured to determine a location of the first user device and forward the location of the first user device to the second user device as a part of the automated notification.

14. The computer program product of claim 8, wherein the apparatus is further configured to transmit a final approval request to the second user device prior to initiating the resource action between the first resource account and the second resource account.

15. A method for multi-channel cognitive virtual assistance for resource transfer requests, the method comprising:
receiving a request from a first user device to complete a resource transfer between a first resource account and a second resource account;
analyzing the request via a machine learning engine and generate an intent based on a communication contained in the request;
generating an automated notification based on the generated intent and forward the automated notification to a second user device;
receiving an approval, denial, or change request in response to the automated notification;
based on the approval, denial, or change request, initiating a resource action between the first resource account and the second resource account.

16. The method of claim 15, wherein the first resource account and the second resource account are managed by a common entity system.

17. The method of claim 15, wherein analyzing the request via the machine learning engine and generating an intent further comprises conducting an analysis of audio communication content in comparison to resource account history data.

18. The method of claim 15, wherein the automated notification further comprises a description of the resource transfer of the request in addition to one or more contextual details.

19. The method of claim 15, wherein the request further comprises a resource amount and one or more products or services, and the method further comprises:
comparing the request to a resource transfer history between the first resource account and the second resource account; and
determining that the request is within a historical range of resource amount or matches products or services of one or more historical resource transfers.

20. The method of claim 15, the method further comprising determining a location of the first user device and forward the location of the first user device to the second user device as a part of the automated notification.
